(19) United States
(12) Patent Application Publication
(10) Pub. No.: US 2015/0314425 A1
(43) Pub. Date: Nov. 5, 2015

(54) RATCHET WRENCH WITH HANDGRIP RATCHET CONTROL

(71) Applicants: JOHN F. MINGARELLI, FRIENDSWOOD, TX (US); JOHN V. FENNER, BACLIFF, TX (US)

(72) Inventors: JOHN F. MINGARELLI, FRIENDSWOOD, TX (US); JOHN V. FENNER, BACLIFF, TX (US)

(21) Appl. No.: 14/480,520

(22) Filed: Sep. 8, 2014

Related U.S. Application Data
(60) Provisional application No. 61/987,896, filed on May 2, 2014.

(51) Int. Cl. B25B 13/46; F16D 41/16; B25G 1/10; B25B 23/00

(52) U.S. Cl. CPC B25B 13/463; B25B 23/0035; F16D 41/16; B25G 1/102

(57) ABSTRACT

The ratchet wrench with handgrip ratchet control includes an axially rotatable rod installed within the handle. The rod is connected to a handgrip disposed externally to the handle. The rod rotates upon manual rotation of the handgrip. An end of the rod adjacent to the wrench head and opposite the handgrip has an axially offset flexible spring pin extending therefrom that engages a blind hole or receptacle in the back of the pawl in the wrench head. Rotation of the handgrip rotates the rod and its pin to swivel the pawl in the selected direction to lock rotation of the wrench drive in one rotational direction, while allowing rotation in the opposite direction. Rotation of the handgrip in the opposite direction reverses the above-described operation. One or more detents may be provided to secure the handgrip in the desired pawl actuating position.

### CROSS-REFERENCE TO RELATED APPLICATION

This application claims the benefit of U.S. Provisional Patent Application Ser. No. 61/987,896, filed May 2, 2014.

### BACKGROUND OF THE INVENTION

1. Field of the Invention

The present invention relates generally to mechanical hand tools and the like, and particularly to a ratchet wrench with handgrip ratchet control so that release and lockup of the rotational direction of the wrench drive is controlled by rotating the handgrip in the appropriate direction about the longitudinal axis of the wrench handle.

2. Description of the Related Art

The conventional ratchet wrench incorporates a reversible ratchet mechanism in the wrench head to allow the drive to rotate in a first direction of rotation while preventing rotation in the opposite second direction. The selector for setting the direction of rotation is conventionally a mechanical toggle, mechanical rotary switch, or other mechanism on or adjacent to the wrench head on the opposite side of the head from the drive. Mechanical advantage is provided by the conventional handle extending from the wrench head, which has a fixed handgrip at the distal end of the handle opposite the wrench head.

While such ratchet wrenches are clearly more convenient than monolithic open end or box end wrenches, the separation of the directional control at the wrench head from the handgrip at the distal end of the handle opposite the wrench head tends to detract from the convenience of the tool in some circumstances. The user of such a conventional wrench must hold the wrench handle with the first hand while using his or her second hand to manipulate the directional control at the wrench head. This may not be a problem for tightening or loosening a single bolt, but may be troublesome when working on a series of bolts that require varying directions of rotation, as when attempting to align and start the threading of a series of bolts in a panel or other component that attaches with a plurality of bolts. Often, it is necessary to back off some of the bolts after they have been tightened in order to allow the component to be shifted slightly to allow other bolts to be aligned and started. The use of a ratchet rotational control adjacent to the wrench head may be cumbersome under such circumstances.

Thus, a ratchet wrench with handgrip ratchet control solving the aforementioned problems is desired.

### SUMMARY OF THE INVENTION

The ratchet wrench with handgrip ratchet control includes a wrench head and an elongate handle or arm extending rigidly therefrom. The wrench head includes a generally circular ratchet therein, and a tool or socket drive affixed to the ratchet and extending axially therefrom. The wrench head further includes an adjustably positionable pawl that selectively engages the ratchet to lock (prevent) rotation of the ratchet in one direction of rotation and allow rotation of the ratchet in the opposite direction of rotation, with the locking and rotational directions being selectively reversible.

Control of the pawl is provided by a rod installed in an axial passage through the wrench handle. The rod has an axially offset flexible spring pin that engages a blind hole or receptacle formed in the back of the pawl, i.e., opposite the teeth of the pawl. The rod is affixed to a handgrip disposed concentrically upon the distal end of the handle, i.e., opposite the wrench head. Handgrip rotation about the elongate axis of the handle results in the rod and the pin rotating in unison with the handgrip. Lateral movement of the pin causes one side of the pawl to pivot to engage the ratchet. The side of the pawl engaging the ratchet is determined by the direction of rotation of the handgrip, rod, and pin, and thus determines the rotational direction of lockup and release of the ratchet and drive of the wrench.

These and other features of the present invention will become readily apparent upon further review of the following specification and drawings.

### BRIEF DESCRIPTION OF THE DRAWINGS

FIG. 1 is an exploded perspective view of a ratchet wrench with handgrip ratchet control according to the present invention, illustrating its various components and their relationships to one another.

FIG. 2 is a top plan view in section of the ratchet wrench with handgrip ratchet control of FIG. 1, showing the wrench set to provide lockup in a first rotational direction and permit rotation in a second rotational direction opposite the first rotational direction.

FIG. 3 is a top plan view in section of the ratchet wrench with handgrip ratchet control of FIG. 1, showing the wrench set to provide lockup in a second rotational direction and permit rotation in a first rotational direction opposite the second rotational direction.

FIG. 4 is an elevation view in section of a prior art ratchet wrench head having a pushbutton socket release mechanism.

Similar reference characters denote corresponding features consistently throughout the attached drawings.

### DETAILED DESCRIPTION OF THE PREFERRED EMBODIMENTS

The ratchet wrench with handgrip ratchet control permits the user of the wrench to select the direction of lockup and rotation of the wrench drive by twisting or rotating the handgrip at the distal end of the handle or arm of the wrench. This provides significant advantages in the use of the wrench, especially when alternately tightening and loosening a series of bolts in an assembly.

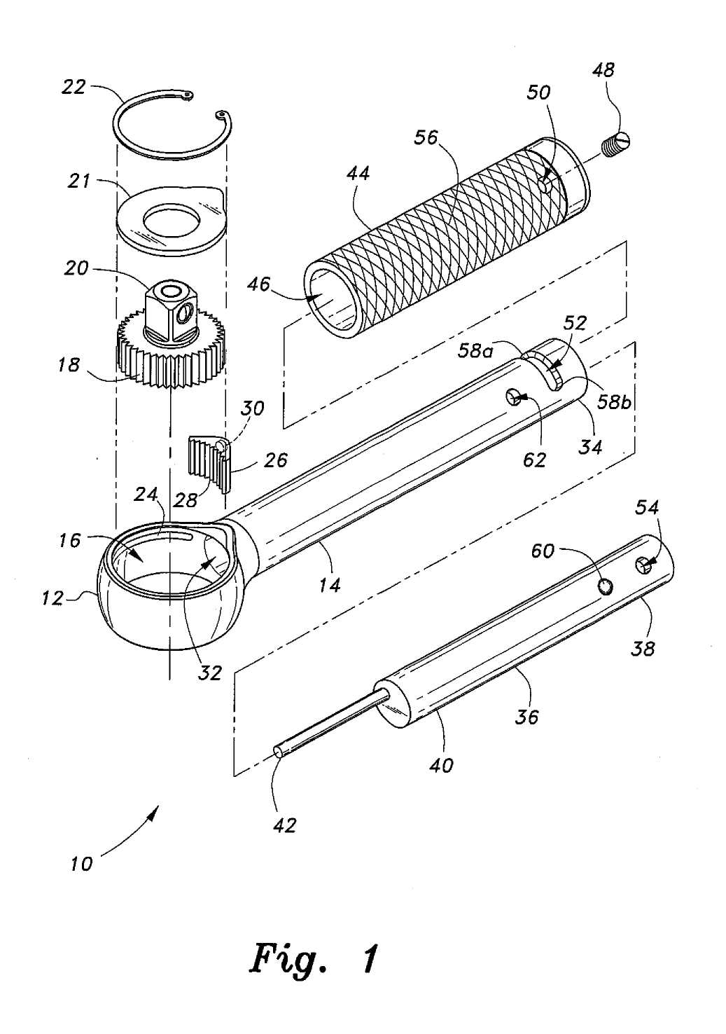

FIG. 1 of the drawings provides an illustration of the various components of the ratchet wrench with handgrip ratchet control 10, indicated as wrench 10 or ratchet wrench 10 throughout the remainder of the disclosure. The wrench 10 comprises a wrench head 12 having a handle or arm 14 rigidly affixed to and extending from the wrench head 12. The wrench head 12 includes a ratchet cavity or receptacle 16. A generally circular, toothed ratchet 18 is installed in the ratchet cavity 16 and selectively rotates therein. A tool drive 20, e.g., a socket drive, is affixed to the ratchet 18 and rotates in unison therewith. The tool drive 20 may have a non-circular section and may be immovably affixed to the ratchet 18. A cover 21 may be installed over the ratchet 18. The cover 21 has a passage therethrough for the tool or socket drive 20. The ratchet 18 and cover 21 are secured within the wrench head 12 by a snap ring 22 that seats in a circumferential groove 24 formed within the head 12. Other means of securing the ratchet 18 and cover 21 within the ratchet cavity 16 of the wrench head 12 may be used, if desired.

A single, unitary pawl 26 is disposed within the ratchet cavity 16 of the wrench head 12 adjacent the juncture of the head 12 and handle or arm 14. The pawl 26 has a ratchet-engaging face having a plurality of teeth 28 thereon that selectively mesh with the teeth of the ratchet 18 to lock (prevent) rotation of the ratchet 18 in a predetermined rotational direction, while allowing rotation of the ratchet 18 in the opposite rotational direction. The pawl 26 selectively pivots arcuately within the wrench head cavity 16 to grip the ratchet 18 with one end or the other of the pawl 26, according to the setting selected by the user and explained further below. The side or face of the pawl 26 opposite its toothed face, i.e., the side or face oriented toward the handle or arm 14, includes a blind receptacle 30 formed therein, i.e., the receptacle 30 does not penetrate completely through the pawl 26 to the toothed face. The pawl 26 is pivoted arcuately within the wrench head cavity 16 by means of this blind receptacle 30, as explained further below.

The handle 14 has a concentric passage 32 therethrough, extending from the distal end of the handgrip end or portion 34 of the handle 14 to its opposite end at the wrench head 12. A rigid rod 36 (i.e., the body of the rod 36 is inflexible, although the rod is rotatably mounted in the handle 14) is installed concentrically inside the handle 14, within the passage 32. The rod 36 has a handgrip attachment end 38 disposed within the handgrip end 34 of the handle 14, and an opposite pawl engagement end 40 communicating with the ratchet cavity 16 of the wrench head 12. A flexible spring pin 42 extends from the pawl engagement end 40 of the rod 36 and is axially offset therefrom, as seen clearly in the various drawings. The pin 42 engages the blind receptacle 30 in the pawl 26, resiliently biasing the pawl 26 against the teeth of the ratchet 18. Rotation of the rod 36 inside the wrench handle 14 results in the pin 42 describing a circular arc. The lateral limits of the arc result in the pin 42 switching the pawl 26 pivotally within the wrench head cavity 16, thereby controlling the locking and rotational directions of the ratchet 18 within the wrench head 12. The blind receptacle 30 in the pawl 26 may be elongated vertically to allow pin travel upward and downward within the receptacle 30, while the pawl 26 remains in the same plane within the wrench head 12, or the flexibility of the pin 42 may allow the pin 42 to flex to accommodate the geometric difference between the circular arc described by the pin 42 and the generally central position of the blind receptacle 30 in the pawl 26.

The rod 36 is rotated by corresponding rotation of a handgrip 44, to which the rod 36 is fixed for rotation therewith. The handgrip 44 has a handle passage 46 formed axially therethrough. The handgrip 44 fits closely over the handgrip end 34 of the handle 14, the handle 14 extending through the handle passage 46. A setscrew 48 or other suitable fastener is installed in a radial passage 50 through the handgrip 44, as shown in FIG. 1, and passes through a semicircumferential slot 52 formed through the hollow handgrip end 34 of the handle 14. While the setscrew or fastener 48 is immovably affixed to the handgrip 44, it is free to rotate radially relative to the handle 14 by means of the semicircumferential slot 52 through which the fastener 48 passes. The fastener 48 also engages a fastener receptacle 54 formed in the handgrip attachment end 38 of the rod 36, as shown in FIG. 1, thereby fixing the handgrip 44 to the rod 36 for rotation therewith through an arc of about 180°. This assembly results in the handgrip 44 being immovably affixed to the rod 36, while allowing the handgrip 44 and rod 36 to rotate in unison with one another relative to the handle 14 by means of the semicircumferential slot 52 in the handle 14. Rotation of the rod 36 by means of handgrip 44 rotation results in the eccentric pin 42 rotating to swivel or pivot the pawl 26 to either side according to the direction of spring force exerted by the spring pin 42 on the receptacle 30 in the pawl 26, thus setting the lockup and rotational directions of the ratchet 18 in the wrench head 12. The handgrip 44 may have a high friction surface 56 to facilitate the grip of the user thereon, e.g., knurling or other roughening, non-slip coating, etc.

The two ends 58a and 58b of the semicircumferential slot 52 serve to limit the arcuate or rotational travel of the setscrew 48 that passes therethrough, and thus the arcuate or rotational travel of the handgrip 44 and the rod 36 to which it is immovably attached. This serves to limit the motion of the pin 30 extending from the pawl engagement end 40 of the rod 36, thus limiting the arcuate movement of the pawl 26 to its optimum limits. A detent 60, e.g., a spring loaded ball, is installed in the handgrip end 38 of the rod 36, and protrudes radially and resiliently therefrom due to an associated spring. The detent 60 selectively engages a detent receptacle 62 formed in the handgrip end 34 of the handle 14 as the handgrip 44 is rotated axially about the handle 14 to secure the handgrip 44 rotationally relative to the handle 14. Two or more detent receptacles 62 may be provided in the handgrip end 34 of the handle 14 to secure the handgrip 14, and the rod 36 to which the handgrip 14 is affixed, to lock the rotation of the ratchet 18 in the desired direction.

The installation of the ratchet directional selection control at the distal or handgrip end 34 of the handle 14 greatly simplifies the provision of other features in the wrench head 12. A highly desirable feature in ratchet wrenches is some means to release a socket that has been installed on the wrench drive. Sockets are conventionally secured removably to the wrench drive by a ball detent, much like the detent 60 described further above, that is seated in a receptacle within the drive attachment portion of the socket. It can sometimes be difficult to remove the socket from the drive if the user of the tool has oily hands and cannot get a firm grip on the socket to pull it past the ball detent of the socket drive.

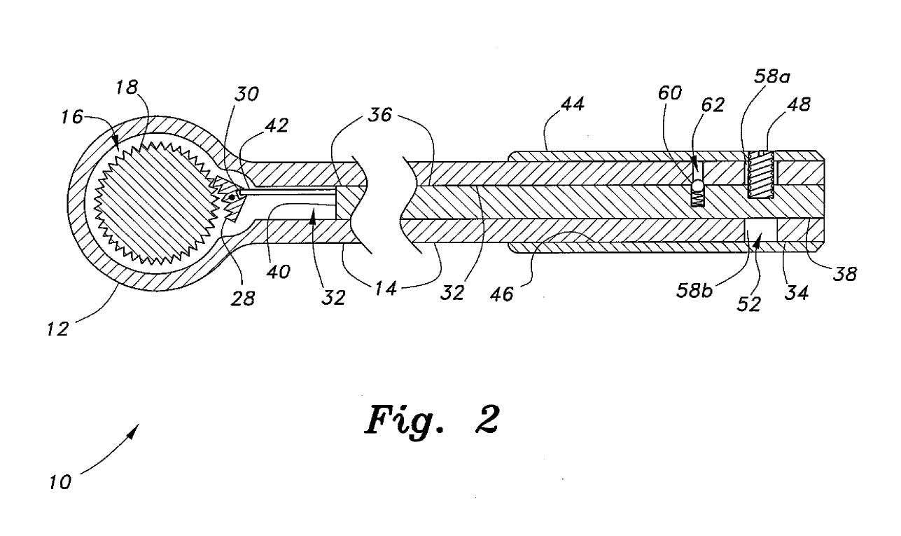

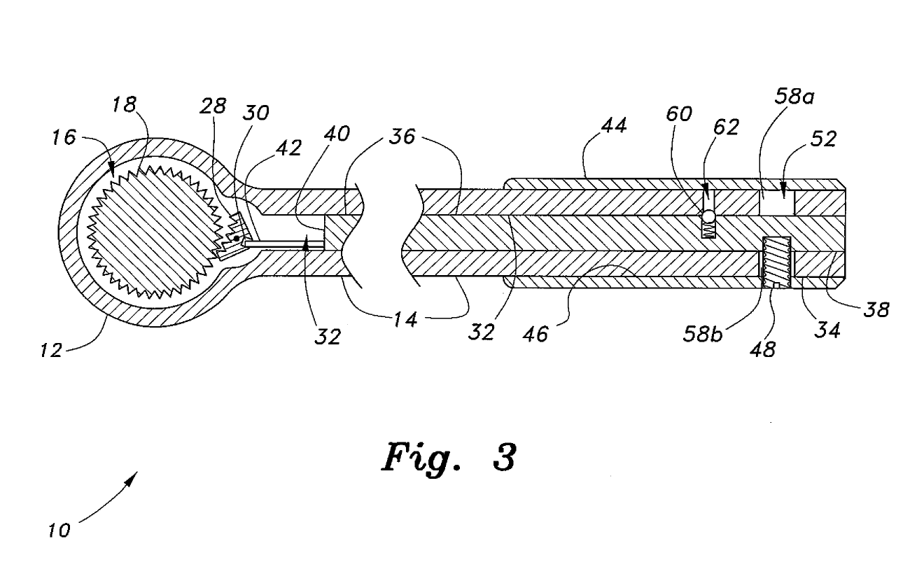

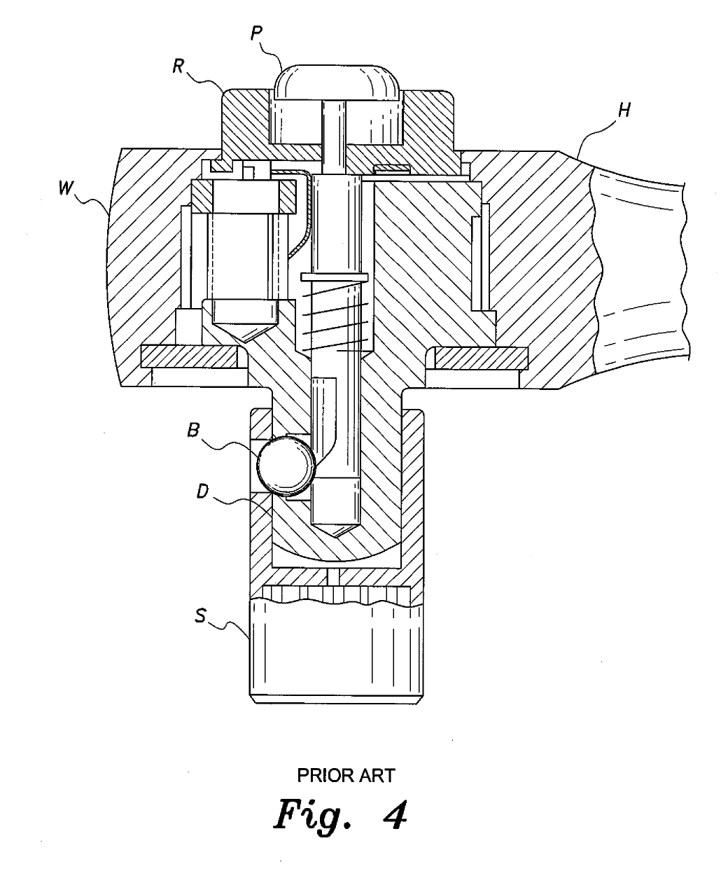

Accordingly, conventional ratchet wrenches are equipped with socket release mechanisms disposed within the wrench head. An example of such is illustrated in prior art FIG. 4. The wrench head W of FIG. 4 includes a ball detent B disposed within the socket drive D. Depression of a pushbutton and plunger P releases the ball detent B to allow the socket S to be removed from the drive D without undue force. It will be noted in FIG. 4 that the wrench head W also includes a ratchet directional selector switch R concentric with the pushbutton and plunger P, and a solid handle H extending from the wrench head W. The entire combination of the pushbutton and plunger P socket release and the ratchet directional selector switch R, as shown in prior art FIG. 4, may be greatly simplified by removing the ratchet directional selector switch R and associated mechanism from the wrench head W and constructing the ratchet wrench in accordance with the ratchet wrench with handgrip ratchet control 10 described in FIGS. 1-3. In other words, the ratchet wrench with handgrip ratchet control 10 may easily incorporate the pushbutton socket release mechanism of the prior art ratchet wrench of FIG. 4, thus providing all of the advantages of both tools, while greatly simplifying the construction of such a wrench.

It is to be understood that the present invention is not limited to the embodiments described above, but encompasses any and all embodiments within the scope of the following claims.

We claim:

1. A ratchet wrench with handgrip ratchet control, comprising:
a wrench head;
a circular ratchet rotatably disposed within the wrench head;
a tool drive extending axially from the ratchet, the tool drive being selectively rotatable in unison with the ratchet;
a pawl disposed within the wrench head, the pawl having a plurality of teeth disposed thereon, the pawl teeth selectively engaging the ratchet, the pawl having a blind receptacle defined therein opposite the pawl teeth;
an elongate, hollow handle extending from the wrench head, the handle having a handgrip end opposite the wrench head;
a handgrip disposed concentrically about the handgrip end of the handle, the handgrip being selectively rotatable coaxially about the handgrip end of the handle;
a rod disposed coaxially through the hollow handle, the rod having a handgrip attachment end and a pawl engagement end opposite the handgrip attachment end, the handgrip being fixed to the rod for selective rotation therewith; and
an eccentric pin extending from the pawl engagement end of the rod, the pin engaging the receptacle in the pawl;
wherein the pawl selectively locks the ratchet to permit the ratchet to rotate in a first direction while preventing rotation in a second direction opposite the first direction, and is switchable by rotation of the handgrip and rod so that the pawl selectively locks the ratchet to permit the ratchet to rotate in the second direction while preventing rotation in the first direction.

2. The ratchet wrench with handgrip ratchet control according to claim 1, wherein the pawl comprises a single, unitary component disposed within the wrench head.

3. The ratchet wrench with handgrip ratchet control according to claim 1, wherein the pin is a flexible spring.

4. The ratchet wrench with handgrip ratchet control according to claim 1, wherein:
the handgrip has a fastener passage defined radially therethrough;
the handgrip end of the handle has an arcuate slot defined therein;
the rod has a fastener receptacle defined radially in the handgrip attachment end; and
the ratchet wrench further comprises a fastener extending through the fastener passage in the handgrip and the slot in the handgrip end of the handle, the fastener being secured in the fastener receptacle of the rod, the fastener immovably affixing the handgrip to the rod for rotation therewith.

5. The ratchet wrench with handgrip ratchet control according to claim 1, further comprising a detent resiliently protruding radially from the handgrip end of the rod, the handgrip end of the handle having at least one detent receptacle defined therein, the detent of the rod selectively engaging the detent receptacle of the handle when the handgrip and rod are rotated axially relative to the handle.

6. The ratchet wrench with handgrip ratchet control according to claim 1, further comprising a high friction grip surface disposed upon the handgrip.

7. The ratchet wrench with handgrip ratchet control according to claim 1, further comprising a socket release mechanism disposed in the wrench head.

8. A ratchet wrench with handgrip ratchet control, comprising:
a wrench head;
a circular ratchet rotatably disposed within the wrench head;
a tool drive extending axially from the ratchet, the tool drive being selectively rotatable in unison with the ratchet;
a single pawl disposed within the wrench head, the pawl having a plurality of teeth disposed thereon, the pawl teeth selectively engaging the ratchet, the pawl having a pin recess defined therein opposite the pawl teeth;
an elongate, hollow handle extending from the wrench head, the handle having a handgrip end opposite the wrench head;
a handgrip disposed coaxially about the handgrip end of the handle, the handgrip being selectively rotatable coaxially about the handgrip end of the handle;
a rod disposed coaxially through the handle, the rod having a handgrip attachment end and a pawl engagement end opposite the handgrip attachment end, the handgrip being fixed to the rod for rotation therewith; and
a pin extending from the pawl engagement end of the rod, the pin being axially offset from the pawl engagement end of the rod, the pin engaging the pin recess of the pawl;
wherein the pawl selectively locks the ratchet to permit the ratchet to rotate in a first direction while preventing rotation in a second direction opposite the first direction, and is switchable by rotation of the handgrip and rod so that the pawl selectively locks the ratchet to permit the ratchet to rotate in the second direction while preventing rotation in the first direction.

9. The ratchet wrench with handgrip ratchet control according to claim 8, wherein the pin recess of the pawl is a blind receptacle.

10. The ratchet wrench with handgrip ratchet control according to claim 8, wherein the pin is a flexible spring biasing said pawl to bear against said ratchet.

11. The ratchet wrench with handgrip ratchet control according to claim 8, wherein:
the handgrip has a fastener passage defined radially therethrough;
the handgrip end of the handle has an arcuate slot defined therein;
the rod has a fastener receptacle defined radially in the handgrip attachment end; and
the ratchet wrench further comprises a fastener extending through the fastener passage in the handgrip and the slot in the handgrip end of the handle, the fastener being secured in the fastener receptacle of the rod, the fastener immovably affixing the handgrip to the rod for rotation therewith.

12. The ratchet wrench with handgrip ratchet control according to claim 8, further comprising a detent resiliently protruding radially from the handgrip end of the rod, the handgrip end of the handle having at least one detent receptacle defined therein, the detent of the rod selectively engaging the detent receptacle of the handle when the handgrip and rod are rotated axially relative to the handle.

13. The ratchet wrench with handgrip ratchet control according to claim 8, further comprising a high friction grip surface disposed upon the handgrip.

14. The ratchet wrench with handgrip ratchet control according to claim 8, further comprising a socket release mechanism disposed in the wrench head.

15. A ratchet wrench with handgrip ratchet control, comprising:
a wrench head;
a ratchet rotatably disposed within the wrench head;
a tool drive extending axially from the ratchet, the tool drive being selectively rotatable in unison with the ratchet;
a pawl disposed within the wrench head, the pawl having a plurality of teeth disposed thereon, the pawl teeth selectively engaging the ratchet, the pawl having a pin recess defined therein opposite the pawl teeth;
an elongate, hollow handle extending from the wrench head, the handle having a handgrip end opposite the wrench head;
a handgrip disposed coaxially about the handgrip end of the handle, the handgrip having a high friction grip surface disposed thereon, the handgrip being selectively rotatable coaxially about the handgrip end of the handle;
a rod disposed coaxially through the handle, the rod having a handgrip attachment end and a pawl engagement end opposite the handgrip attachment end, the handgrip being fixed to the rod for rotation therewith; and
a flexible, eccentric spring pin extending from the pawl engagement end of the rod, the pin being axially offset from the pawl engagement end of the rod, the pin engaging the pin recess of the pawl and resiliently biasing the pawl into contact with the ratchet;
wherein the pawl selectively locks the ratchet to permit the ratchet to rotate in a first direction while preventing rotation in a second direction opposite the first direction, and is switchable by rotation of the handgrip and rod so that the pawl selectively locks the ratchet to permit the ratchet to rotate in the second direction while preventing rotation in the first direction.

16. The ratchet wrench with handgrip ratchet control according to claim 15, wherein the pin recess in the pawl is a blind receptacle.

17. The ratchet wrench with handgrip ratchet control according to claim 15, wherein the pawl comprises a single, unitary component disposed within the wrench head.

18. The ratchet wrench with handgrip ratchet control according to claim 15, wherein:
the handgrip has a fastener passage defined radially therethrough;
the handgrip end of the handle has an arcuate slot defined therein;
the rod has a fastener receptacle defined radially in the handgrip attachment end; and
the ratchet wrench further comprises a fastener extending through the fastener passage in the handgrip and the slot in the handgrip end of the handle, the fastener being secured in the fastener receptacle of the rod, the fastener immovably affixing the handgrip to the rod for rotation therewith.

19. The ratchet wrench with handgrip ratchet control according to claim 15, further comprising a detent resiliently protruding radially from the handgrip end of the rod, the handgrip end of the handle having at least one detent receptacle defined therein, the detent of the rod selectively engaging the detent receptacle of the handle when the handgrip and rod are rotated axially relative to the handle.

20. The ratchet wrench with handgrip ratchet control according to claim 15, further comprising a socket release mechanism disposed in the wrench head.
